(19) United States
(12) Patent Application Publication
(10) Pub. No.: US 2015/0324428 A1
(43) Pub. Date: Nov. 12, 2015

(54) Interactive Search Queries

(71) Applicants: Daniel M. Crichton, Eden Prairie, MN (US); Frances B. HAUGEN, Mountain View, CA (US)

(72) Inventors: Daniel M. Crichton, Eden Prairie, MN (US); Frances B. HAUGEN, Mountain View, CA (US)

(21) Appl. No.: 13/605,025

(22) Filed: Sep. 6, 2012

Related U.S. Application Data
(60) Provisional application No. 61/531,232, filed on Sep. 6, 2011.

(51) Int. Cl. G06F 17/30

(52) U.S. Cl. CPC G06F 17/30528; G06F 17/30554; G06F 17/30867; G06F 17/30507

(57) ABSTRACT

A method performed by one or more processing devices includes obtaining, based on an execution of a query by the one or more processing devices, one or more search results for the query; generating, based on the query and the one or more search results, a data object for the query; and receiving, through a visual representation of the data object rendered on a computer display of a client device, data indicative of a user interaction with the data object.

### CLAIM OF PRIORITY

This application claims priority under 35 U.S.C. §119(e) to provisional U.S. Patent Application No. 61/531,232, filed on Sep. 6, 2011, the entire contents of which are hereby incorporated by reference.

### BACKGROUND

This disclosure relates generally to generating interactive search queries, e.g., search queries that can be shared and annotated.

Search engines identify resources (e.g., images, audio, video, Web pages, text, documents) that are relevant to a user's needs and present information about the resources in a manner that is useful to the user.

### SUMMARY

In one aspect of the present disclosure, a method performed by one or more processing devices includes obtaining, based on an execution of a query by the one or more processing devices, one or more search results for the query; generating, based on the query and the one or more search results, a data object for the query; and receiving, through a visual representation of the data object rendered on a computer display of a client device, data indicative of a user interaction with the data object.

Implementations of the disclosure can include one or more of the following features. In some implementations, the method also includes generating data for a graphical user interface that depicts an activity stream, with the visual representation of the data object being depicted in the activity stream; wherein causing the data object to be rendered on the display device includes: sending the graphical user interface to the display device.

In other implementations, the visual representation of the data object includes a visual representation of the content of the query. In still other implementations, the visual representation of the data object includes one or more controls for performance of one or more actions on the query, and wherein the method further includes: analyzing data specifying a number of actions performed on the query.

In some implementations, the method includes analyzing one or more metrics for the query; and storing the one or more metrics in the data object; wherein at least one of the one or more metrics includes one or more of: a measure of a number of users that has viewed the one or more search results for the query; and a measure of a number of users that has requested the execution of the query. In still other implementations, the data object includes data describing one or more attributes of the query, and wherein the method further includes: indexing the data object in accordance with the one or more attributes.

In some implementations, the data pertaining to the query includes one or more of: data indicative of a comment about the query; data indicative of an endorsement of the query; data indicative of a sharing of the query with users of a service configured for implementation by the one or more processing devices.

In still another aspect of the disclosure, one or more machine-readable media are configured to store instructions that are executable by one or more processing devices to perform operations including obtaining, based on an execution of a query by the one or more processing devices, one or more search results for the query; generating, based on the query and the one or more search results, a data object for the query; and receiving, through a visual representation of the data object rendered on a computer display of a client device, data indicative of a user interaction with the data object. Implementations of this aspect of the present disclosure can include one or more of the foregoing features.

In still another aspect of the disclosure, an electronic system includes one or more processing devices; and one or more machine-readable media configured to store instructions that are executable by the one or more processing devices to perform operations including: obtaining, based on an execution of a query by the one or more processing devices, one or more search results for the query; generating, based on the query and the one or more search results, a data object for the query; and receiving, through a visual representation of the data object rendered on a computer display of a client device, data indicative of a user interaction with the data object. Implementations of this aspect of the present disclosure can include one or more of the foregoing features.

In an example, the techniques described herein may advantageously make a query an object for display on a web page in a social network, e.g., by allowing users to endorse the query, share the query with friends, and so forth. In an example, the system displays a shared query as an object in web pages of users connected to each other in a social network. By displaying the query as an object in a web page, the system promotes users commenting on the query and using the query in building an online community, e.g., a community of users that post comments on the query. Additionally, by displaying the query as an object in the web page, users may educate other users on how to build efficient and effective queries, e.g., by allowing users to view contents an efficient, effective query.

All or part of the foregoing can be implemented as a computer program product including instructions that are stored on one or more non-transitory machine-readable storage media, and that are executable on one or more processing devices. All or part of the foregoing can be implemented as an apparatus, method, or electronic system that can include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF DRAWINGS

FIG. 1 is a conceptual diagram of an example of a system for generating a query data object.

FIG. 2 is a block diagram showing examples of components of a system for generating a query data object.

FIG. 3 is a flow chart of an example of a process for generating a query data object.

FIG. 4 is a flow chart of an example of a process for analyzing performance of actions on a query.

FIG. 5 shows an example of a computer device and a mobile computer device that can be used to implement the techniques described herein.

Like reference symbols and designations in the various drawings indicate like elements.

### DETAILED DESCRIPTION

A system consistent with this disclosure collects metadata about a query (e.g., a text query and/or an image query) and displays the metadata and contents of the query in an activity stream. Generally, an activity stream includes a graphical user interface that displays data published by users of a system, e.g., a social networking system. In an example, the data published by users of the system are stored in data objects. Generally, a data object includes a data structure for storage of data.

In an example, the system generates data objects for numerous types of data, including, e.g., a data object for an update to a profile page, a data object for a post to a web page, a data object for a picture displayed in a web page, a data object for a query requested by a user (“query data object”), and so forth. In this example, the system is configured to display contents of the data objects in the activity stream. Using the query data object displayed in the activity stream, a user may post comments about the query and share the query with other users of the system.

In an example, the user submits to the system a request to search for resources related to a celebrity, e.g., a celebrity named “Joe Jones.” In this example, the request includes the search query “Joe Jones.” Using the search query, the system generates a query to identify in the system and/or in the World Wide Web resources related to Joe Jones. In this example, the system also generates search results for the resources. A search result includes data generated by the system that identifies a resource and that includes a link to the resource.

Using the search query and the search results, the system generates a query data object for the query. The query data object includes the contents of the query, e.g., the search query “Joe Jones.” The query data object also includes the search results. The query data object also includes metadata about the query, including, e.g., data indicative of a number of search results that the system identified in response to the query. The query data object is displayed in activity streams of users of the system.

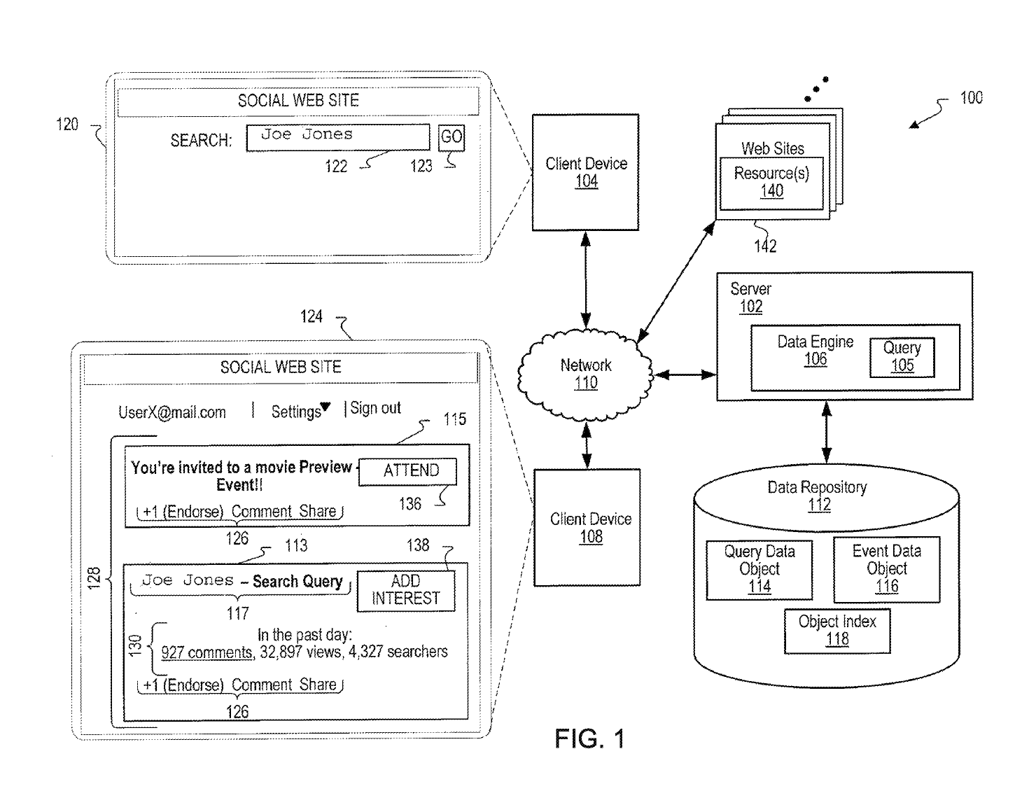

FIG. 1 is a conceptual diagram of an example of system 100 for generating query data object 114. System 100 includes server 102, client devices 104, 108 and network 110. Client devices 104, 108 can each communicate with server 102 over network 110. Users (not shown) may use client devices 104, 108 to access and to view resources, including, e.g., graphical user interfaces 120, 124.

Server 102 includes data engine 106, which is configured run numerous services, including, e.g., a social networking service, an Internet crawl service, and so forth. In the example of FIG. 1, data engine 106 crawls resources 140 of web sites 142. In an example, web sites 142 may be hosted by servers (not shown) that are external to system 100. In another example, web sites 142 may be hosted by server 102.

Based on the crawling of resources 140, data engine 106 identifies content in resources 140. Using content in resources 140, data engine 106 generates data objects for display in activities streams of users of the social networking service. A data object may identify a query and include a link to search results of the query. In an example, the data object includes information specifying search query in the query, a URL (Unified Resource Location) to a web page that displays the search results of the query, and metadata about the query.

In an example, server 102 includes a search engine with various components, including, e.g., a component for crawling resources 140, a component for indexing resources 140, and data engine 106. In this example, data engine 106 may receive from the other components of the search engine data that is used to generate the data objects. In this example, data engine 106 may be a separate component in the search engine.

As previously described, server 102 includes another component for receiving information from social networking services and/or web sites (“social networking component”). In this example, web sites 142 are hosted by server 102, and resources 140 include a web page that is accessible to users of the social networking service. In this example, the web page includes a posting inviting users of the social networking service to an event, e.g., a movie preview. The social networking components receives contents of the web page for the event and passes the content to data engine 106. Using the contents, data engine 106 generates a data object for the event (“event data object 116”).

Event data object 116 may be displayed in activity streams of users of the social networking service based on affinities of the users to other users, e.g., when the users have a connection to other users that have viewed the event. Generally, a connection includes a relationship among items of data, including, e.g., among an item of data representing a user and items of data in a web page, among the item of data representing the user and another item of data representing another user, and so forth. In this example, the connection may be established based on performance of actions, including, e.g., viewing the web page, endorsing the web page, posting a comment on the web page, being connected to another user that has performed one of the foregoing actions, and so forth.

Data engine 106 may also be configured to generate other types of data objects, including, e.g., query data object 114. Data engine 106 may use contents of graphical user interface 120 in generating data query data object 114.

In the example of FIG. 1, client device 104 accesses graphical user interface 120 from server 102. In this example, graphical user interface 120 includes a web page with field 122 for input of search query.

By inputting a search query into field 122, a user (not shown) of client device 104 may request that server 102 perform a search of resources 140 for content related to the search queries input into field 122. In this example, the user inputs the search query “Joe Jones” into field 122 of graphical user interface 120. The user selects control 123 to request that server 102 search resources 140 for content related to the search query “Joe Jones.”

In response, data engine 106 generates query 105 to search in resources 140 for content related to the search query “Joe Jones.” Data engine 106 also generates search results (not shown) to identify the resources including content related to the search query “Joe Jones.”

Using contents of query 105 and the search results, data engine 106 generates query data object 114 for storage of query 105, search results of query 105, and metadata pertaining to query 105. Using query data object 114, users may post comments regarding an effectiveness of query 105. Using query data object 114, users may also share query 105 among other users of the social networking service. Through query data object 114, users may also view metadata pertaining to query 105 and may view search results of query 105.

In an example, the search results accessed through query data object 114 include cached search results generated by data engine 106 during a prior execution of query 105. In another example, the search results are refreshed search results generated by data engine 106 through an execution of query 105, e.g., when the search results requested through query data object 114.

System 100 also includes data repository 112 for storage of query data object 114 and event data object 116. Data repository 112 also includes object index 118 for storing information that indexes data objects, including, e.g., query data object 114 and event data object 116.

In an example, query data object 114 includes a timestamp specifying a time in which data engine 106 performed query 105. Event data object 116 also includes a timestamp specifying a time in which the event for event data object 116 was posted on resources 140 in websites 142. In this example, data engine 106 indexes query data object 114 and event data object 116 in object index 118 based on the respective timestamps.

In an example, data engine 106 also indexes query data object 114 and event data object 116 in object index 118 based on respective permission levels. Generally, a permission level includes data specifying identities of users of the social networking service that are authorized to access a data object.

A user may specify the permission level for a data object. In an example, the user of client device 104 may use controls (not shown) in graphical user interface 120 to specify that query 105 is accessible to users connected in the social networking service to the user of client device 104. In another example, the user of client device 104 may specify that query 105 is accessible to the users of the social networking service. Using the specified accessibility for query 105, data engine 106 generates a permission level for query data object 114. Data engine 106 stores the permission level as metadata in query data object 114.

In some implementations, users may also specify whether data objects should be generated for their queries, e.g., by opting-in or opting-out of generating data objects for their queries. In some implementations, the data in the data objects can be anonymized to promote privacy of users. In this example, the system implements a hashing function to encrypt the data and other content that the system identifies to anonymize. For example, data repository 108 stores the data for the attributes in an encrypted form to promote secure storage of the data.

In the example of FIG. 1, a user (not shown) of client device 108 uses client device 108 to access graphical user interface 124 from server 102. Graphical user interface 124 includes a web page that displays activity stream 128 for the user of client device 108.

In the example of FIG. 1, data engine 106 accesses object index 118 to determine data objects for display in activity stream 128. In an example, data engine 106 is configured to display in activity stream 128 recently generated data objects that the user of client device 108 is authorized to access. Generally, recently generated data objects include data objects with timestamps with increased proximity to a time that data engine 106 generates data stream 128 (“generation time”), e.g., relative to a proximity of timestamps of other data objects to the generation time. Using timestamps in query data object 114 and event data object 116, data engine 106 identifies query data object 114 and event data object 116 as recently generated data objects.

In the example of FIG. 1, event data object 116 has a permission level specifying that users connected to the user that published the event may view event data object 116. Query data object 114 has a permission level specifying that users connected to the user that submitted the request for query 105 may view query data object 114. In this example, the user of client device 108 is connected in the social networking service to both the user that published the event and the user that submitted the request for query 105.

Using the permission levels of query data object 114 and event data object 116, data engine 106 determines that the user of client device 108 has permission to access query data object 114 and event data object 116. Data engine 106 selects query data object 114 and event data object 116 for display in activity stream 128. To display contents of query data object 114 and event data object 116 in activity stream 128, data engine 106 generates data for visual representation 113 of query data object 114 and data for visual representation 115 of event data object 116.

Visual representation 113 includes portion 117 that displays the search query of query 105 (e.g., “Joe Jones”). Portion 117 of visual representation 113 also includes data specifying a type of data object for query data object 114. In the example of FIG. 1, query data object 114 is a “search query” type of data object.

In an example, portion 117 includes selectable data, e.g., the search query. When the search query are selected by the user of client device 108, data engine 106 retrieves from query data object 114 the original search results for query 105. In another example, when the search query is selected by the user of client device 108, data engine 106 generates new search results by re-executing query 105. Data engine 106 sends to client device 108 the search results for display in graphical user interface 124. In another example, the selectable data includes one or more images.

In the example of FIG. 1, visual representations 113, 115 each include controls 126 by which the user of client device 108 may perform various actions. For the event data object 116, the actions include commenting on contents of event data object 116, endorsing the contents of event data object 116, and sharing the contents of event data object 116 with other users of the social networking service running on server 102. For query data object 114, the actions include commenting on query 10, endorsing query 105, and sharing query 105 with other users of the social networking service running on server 102.

In the example of FIG. 1, data engine 106 also analyzes metrics associated with query data object 114 and/or with query 105. The metrics may include a measure of a number of times visual representation 113 of query data object 114 has been viewed by users of the social networking service. The metrics may also include a measure of a number of times users have requested that data engine perform query 105. The metrics may also include a measure of a number of actions that have been performed on query 105 with controls 126, including, e.g., a number of comments that have been posted for query 105. The metrics are stored as metadata in query data object 114.

Visual representation 113 may also display data indicative of portions of the metadata stored in query data object 114. In the example of FIG. 1, visual representation 113 displays data 130 indicative of metadata included in query data object 114. Data 130 specifies a number of comments that has been made about query 105, a number of users of the social networking service that has viewed visual representation 113 of query data object 114 for query 105, and a number of users that has requested that data engine perform query 105.

In the example of FIG. 1, the portion of data 130 pertaining to the number of comments includes selectable data. When a user selects the selectable data, data engine 106 causes graphical user interface 124 to display a listing of the comments.

Visual representations 113, 115 also include controls 136, 138, respectively. Through control 136, the user of client device 108 may request that data engine 106 generate a response to the invitation to attend the event and send the response to an e-mail address for the event. Through control 138, the user of client device 108 may request that data engine 106 add query data object 114 to a list of interests in a profile of the user for the social networking service.

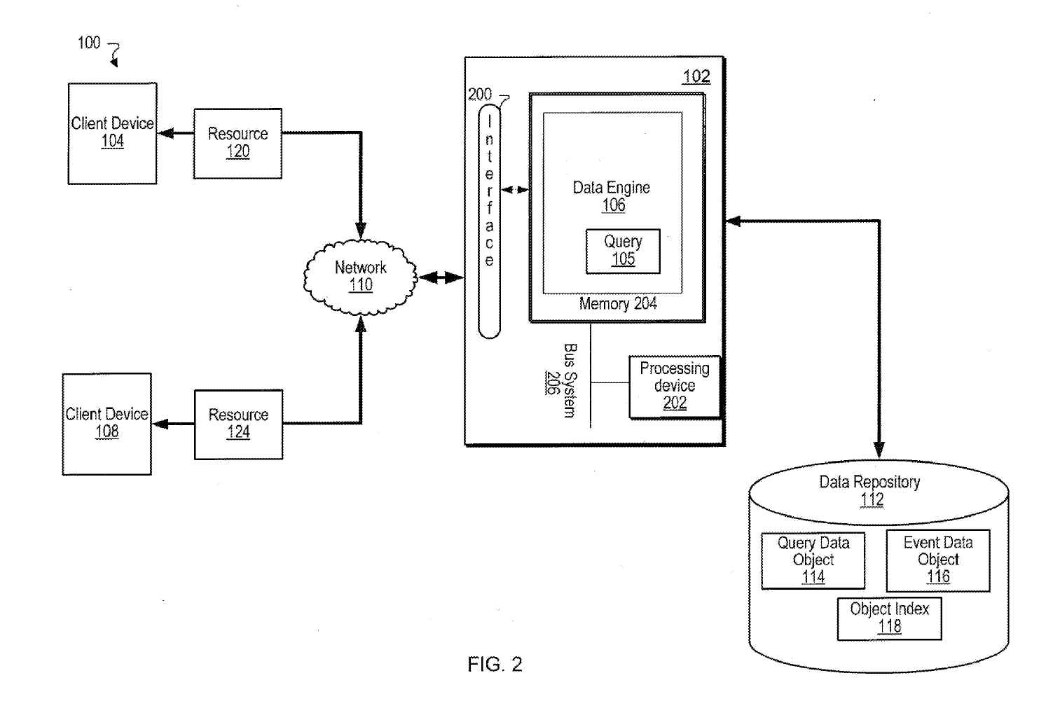

FIG. 2 is a block diagram showing examples of components of system 100 for generating query data object 114. In the example of FIG. 2, contents of graphical user interfaces 120, 124 are not shown.

Client devices 104, 108 can each be a computing device capable of taking input from a user and communicating over network 110 with server 102 and/or with other client devices. For example, client devices 104, 108 can each be mobile devices, desktop computers, laptops, cell phones, personal digital assistants (PDAs), servers, embedded computing systems, mobile devices, and the like. System 100 can include a plurality of client devices, which can be geographically dispersed.

Network 110 can include a large computer network, including, e.g., a local area network (LAN), wide area network (WAN), the Internet, a cellular network, or a combination thereof connecting a number of mobile computing devices, fixed computing devices, and server systems. The network(s) may provide for communications under various modes or protocols, including, e.g., Transmission Control Protocol/Internet Protocol (TCP/IP), Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. Communication may occur through a radio-frequency transceiver. In addition, short-range communication may occur, including, e.g., using a Bluetooth, WiFi, or other such transceiver.

Server 102 can be a variety of computing devices capable of receiving data and running one or more services, which can be accessed by client devices 104, 108. In an example, server 102 can include a server, a distributed computing system, a desktop computer, a laptop, a cell phone, a rack-mounted server, and the like. Server 102 can be a single server or a group of servers that are at a same location or at different locations. Client devices 104, 108 and server 102 can run programs having a client-server relationship to each other. Although distinct modules are shown in the figures, in some examples, client and server programs can run on the same device.

Server 102 can receive data from client devices 104, 108 through input/output (I/O) interface 200. I/O interface 200 can be a type of interface capable of receiving data over a network, including, e.g., an Ethernet interface, a wireless networking interface, a fiber-optic networking interface, a modem, and the like. Server 102 also includes a processing device 202 and memory 204. A bus system 206, including, for example, a data bus and a motherboard, can be used to establish and to control data communication between the components of server 102.

Processing device 202 can include one or more microprocessors. Generally, processing device 202 can include an appropriate processor and/or logic that is capable of receiving and storing data, and of communicating over a network (not shown). Memory 204 can include a hard drive and a random access memory storage device, including, e.g., a dynamic random access memory, or other types of non-transitory machine-readable storage devices. As shown in FIG. 2, memory 204 stores computer programs that are executable by processing device 202. These computer programs include data engine 106.

Data engine 106 can be implemented in software running on a computer device (e.g., server 102), hardware or a combination of software and hardware. Although data engine 106 is shown as a single component in FIGS. 1 and 2, data engine 106 can exist in one or more components, which can be distributed and coupled by one or more networks (not shown). Additionally, data engine 106 may be a component in a search engine.

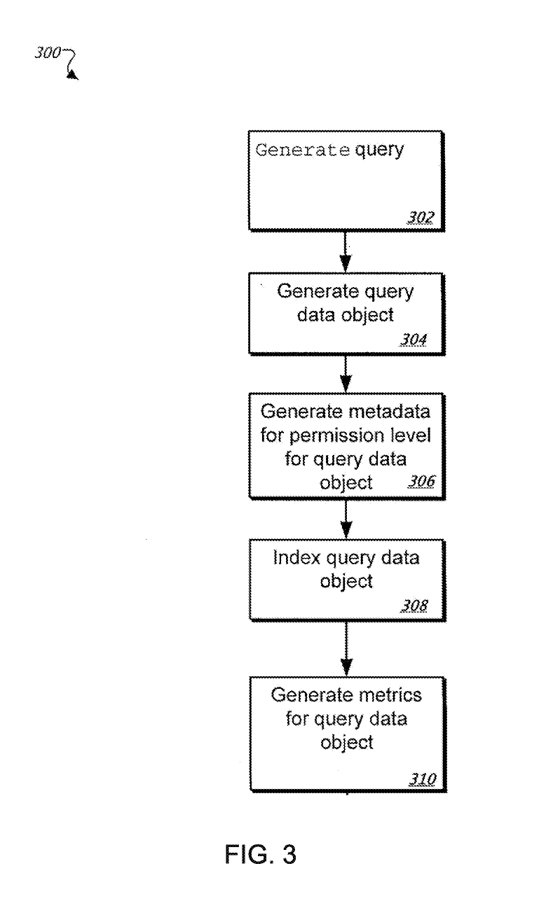

FIG. 3 is a flow chart of an example of process 300 for generating query data object 114. In operation, data engine 106 generates (302) query 105 with one or more search query. Data engine 106 executes (not shown) query 105 and generates (not shown) search results for query 105.

Using search query in query 105 and the search results, data engine 106 generates (304) query data object 114. In an example, query data object 114 includes portions of the query 105, e.g., as illustrated in portion 117 of visual representation 113 of graphical user interface 124 (FIG. 1). Query data object 114 also includes one or more of the search results for query 105 or a pointer to the one or more search results for query 105. Generally, a pointer includes a reference from one item of data to another item of data.

Data engine 106 also identifies a permission level for query data object 114. As previously described, a user of client device 104 (FIG. 1) may use controls (not shown) in graphical user interface 120 to specify the users that are authorized to access query data object 114. In this example, client device 104 sends (not shown) to server 102 data specifying the users that are authorized to access query data object 114. Using the data specifying the users that are authorized to access query data object 114, data engine 106 generates (306) metadata specifying a permission level for query data object 114. The metadata is stored in data object query 114.

In an example, data engine 106 may also generate other metadata describing attributes of query data object 114. Generally, an attribute includes data describing characteristics and/or qualities of an item of data. In this example, the attributes for query data object 114 may include a timestamp specifying a time that query 105 was performed by data engine 106. In some implementations, data engine 106 may send other attributes of query data object 114, including, e.g., data specifying anonymized identities of users that have requested that data engine 106 perform query 105, data specifying anonymized identities of users that have viewed the search results of query 105, data specifying anonymized identities of users that have viewed visual representation 113 of query data object 114, data specifying anonymized identities of users that have used controls 126 (FIG. 1) to perform an action on query 105, and so forth, e.g., when the users have provided permission (e.g., through opt-in or opt-out features) for use of the data.

Data engine 106 also indexes (306) query data object 114 in object index 118. Data engine 106 may use attributes of query data object 114 to index query data object 114 in object index 118. Query data object 114 may be indexed in object index 118 based on a timestamp for query data object 114, based on a permission level for query data object 114, and so forth.

In the example of FIG. 3, data engine 106 generates (310) metrics for query 105 and stores these metrics in query data object 114. These metrics may include measures of a number of users that has requested that data engine 106 perform query 105, measures of a number of users that has commented on query 105, measures of a number of users that has viewed search results for query 105, and measures of a number of users that has endorsed query 105. The metrics may be initialized to pre-defined values, including, e.g., a value of zero.

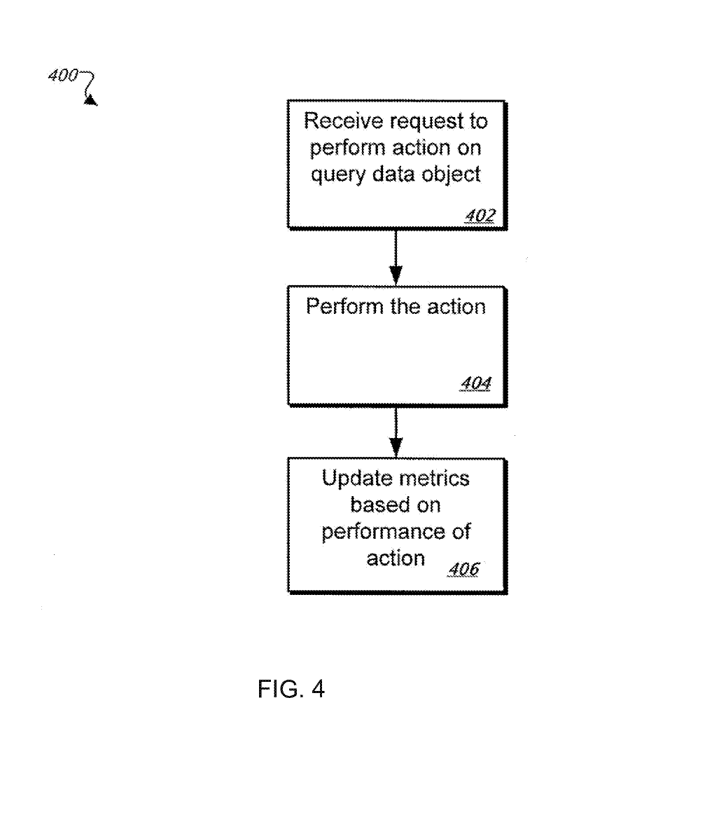

As actions are performed on query 105, data engine 106 may increment in data query object 114 values of the metrics pertaining to the performed actions, as described in further detail with regard to FIG. 4. As searches are performed using query 105, data engine 106 also increments in query data object 114 the value of metrics pertaining to numbers of users that have requested that data engine 106 perform query 105.

FIG. 4 is a flow chart of an example of process 400 for analyzing performance of actions on query 105. In operation, data engine 106 receives (402) a request (not shown) for performance of an action on query 105, e.g., following selection of one of controls 126 by the user of client device 108 (FIG. 1). As previously described, the user of client device 108 may request that data engine 106 perform numerous actions on query 105. The actions include posting a comment to query 105, endorsing query 105, and sharing query 105 with other users of the social networking service running on server 102.

In the example of FIG. 4, data engine 106 performs (404) the action requested by the user of client device 108. Data engine 106 also updates (406) metrics in query data object 114 to reflect performance of the action. In an example, data engine 106 performs an action of posting a comment to query 105. Following the posting of the comment, data engine 106 accesses in query data object 114 a metric specifying a number of comments that have been posted to query 105. Data engine 106 increments by a value of one a value of the metric.

Using the techniques described herein, a system in configured to use contents of a query in generating a query data object that stores metadata about the query and search query in the query. The system can display a visual representation of the query data object in an activity stream. Using controls in the visual representation, a user of the system may request that the system perform various actions on the query. Using the query data object, the system analyzes the actions performed on the query.

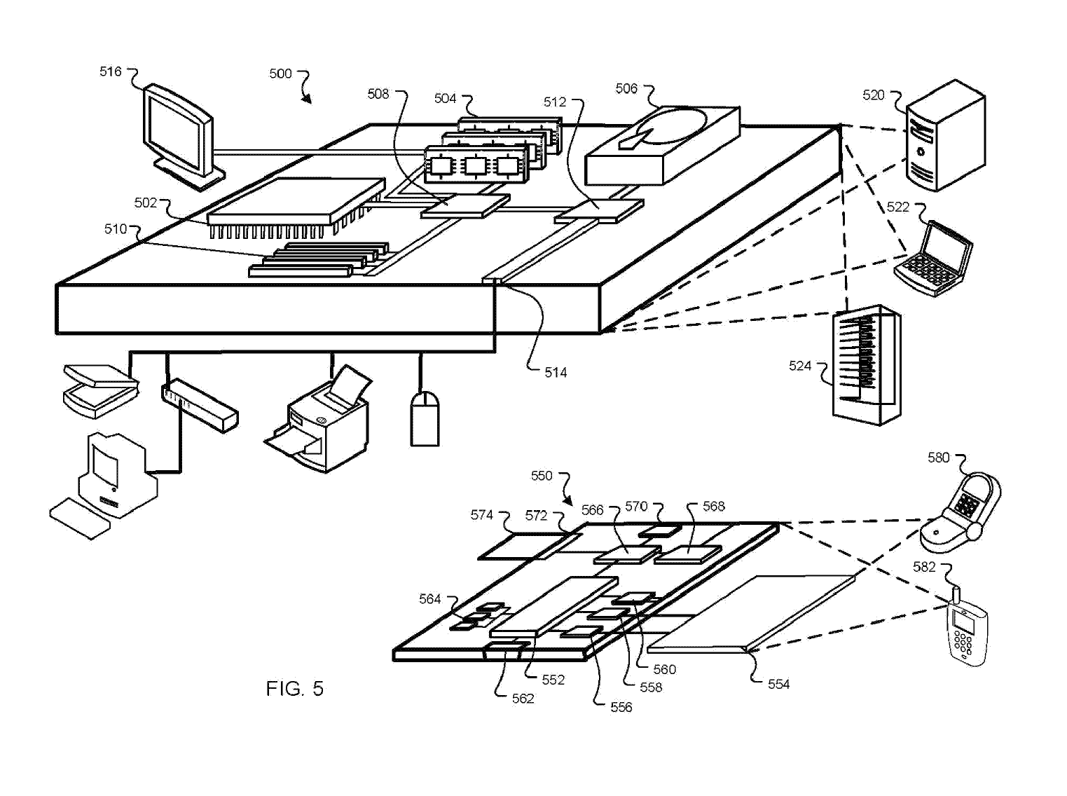

FIG. 5 shows an example of computer device 500 and mobile computer device 550, which can be used with the techniques described here. Computing device 500 is intended to represent various forms of digital computers, including, e.g., laptops, desktops, workstations, personal digital assistants, servers, blade servers, mainframes, and other appropriate computers. Computing device 550 is intended to represent various forms of mobile devices, including, e.g., personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 500 includes processor 502, memory 504, storage device 506, high-speed interface 508 connecting to memory 504 and high-speed expansion ports 510, and low speed interface 512 connecting to low speed bus 514 and storage device 506. Each of components 502, 504, 506, 508, 510, and 512, are interconnected using various busses, and can be mounted on a common motherboard or in other manners as appropriate. Processor 502 can process instructions for execution within computing device 500, including instructions stored in memory 504 or on storage device 506 to display graphical data for a GUI on an external input/output device, including, e.g., display 516 coupled to high speed interface 508. In other implementations, multiple processors and/or multiple buses can be used, as appropriate, along with multiple memories and types of memory. Also, multiple computing devices 500 can be connected, with each device providing portions of the necessary operations (e.g., as a server bank, a group of blade servers, or a multi-processor system).

Memory 504 stores data within computing device 500. In one implementation, memory 504 is a volatile memory unit or units. In another implementation, memory 504 is a non-volatile memory unit or units. Memory 504 also can be another form of computer-readable medium, including, e.g., a magnetic or optical disk.

Storage device 506 is capable of providing mass storage for computing device 500. In one implementation, storage device 506 can be or contain a computer-readable medium, including, e.g., a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, including, e.g., those described above. The data carrier is a computer- or machine-readable medium, including, e.g., memory 504, storage device 506, memory on processor 502, and the like.

High-speed controller 508 manages bandwidth-intensive operations for computing device 500, while low speed controller 512 manages lower bandwidth-intensive operations. Such allocation of functions is an example only. In one implementation, high-speed controller 508 is coupled to memory 504, display 516 (e.g., through a graphics processor or accelerator), and to high-speed expansion ports 510, which can accept various expansion cards (not shown). In the implementation, low-speed controller 512 is coupled to storage device 506 and low-speed expansion port 514. The low-speed expansion port, which can include various communication ports (e.g., USB, Bluetooth®, Ethernet, wireless Ethernet), can be coupled to one or more input/output devices, including, e.g., a keyboard, a pointing device, a scanner, or a networking device including, e.g., a switch or router, e.g., through a network adapter.

Computing device 500 can be implemented in a number of different forms, as shown in the figure. For example, it can be implemented as standard server 520, or multiple times in a group of such servers. It also can be implemented as part of rack server system 524. In addition or as an alternative, it can be implemented in a personal computer including, e.g., laptop computer 522. In some examples, components from computing device 500 can be combined with other components in a mobile device (not shown), including, e.g., device 550. Each of such devices can contain one or more of computing device 500, 550, and an entire system can be made up of multiple computing devices 500, 550 communicating with each other.

Computing device 550 includes processor 552, memory 564, an input/output device including, e.g., display 554, communication interface 566, and transceiver 568, among other components. Device 550 also can be provided with a storage device, including, e.g., a microdrive or other device, to provide additional storage. Each of components 550, 552, 564, 554, 566, and 568, are interconnected using various buses, and several of the components can be mounted on a common motherboard or in other manners as appropriate.

Processor 552 can execute instructions within computing device 550, including instructions stored in memory 564. The processor can be implemented as a chipset of chips that include separate and multiple analog and digital processors. The processor can provide, for example, for coordination of the other components of device 550, including, e.g., control of user interfaces, applications run by device 550, and wireless communication by device 550.

Processor 552 can communicate with a user through control interface 558 and display interface 556 coupled to display 554. Display 554 can be, for example, a TFT LCD (Thin-Film-Transistor Liquid Crystal Display) or an OLED (Organic Light Emitting Diode) display, or other appropriate display technology. Display interface 556 can comprise appropriate circuitry for driving display 554 to present graphical and other data to a user. Control interface 558 can receive commands from a user and convert them for submission to processor 552. In addition, external interface 562 can communicate with processor 542, so as to enable near area communication of device 550 with other devices. External interface 562 can provide, for example, for wired communication in some implementations, or for wireless communication in other implementations, and multiple interfaces also can be used.

Memory 564 stores data within computing device 550. Memory 564 can be implemented as one or more of a computer-readable medium or media, a volatile memory unit or units, or a non-volatile memory unit or units. Expansion memory 574 also can be provided and connected to device 550 through expansion interface 572, which can include, for example, a SIMM (Single In Line Memory Module) card interface. Such expansion memory 574 can provide extra storage space for device 550, or also can store applications or other data for device 550. Specifically, expansion memory 574 can include instructions to carry out or supplement the processes described above, and can include secure data also. Thus, for example, expansion memory 574 can be provide as a security module for device 550, and can be programmed with instructions that permit secure use of device 550. In addition, secure applications can be provided through the SIMM cards, along with additional data, including, e.g., placing identifying data on the SIMM card in a non-hackable manner.

The memory can include, for example, flash memory and/or NVRAM memory, as discussed below. In one implementation, a computer program product is tangibly embodied in an data carrier. The computer program product contains instructions that, when executed, perform one or more methods, including, e.g., those described above. The data carrier is a computer- or machine-readable medium, including, e.g., memory 564, expansion memory 574, and/or memory on processor 552, that can be received, for example, over transceiver 568 or external interface 562.

Device 550 can communicate wirelessly through communication interface 566, which can include digital signal processing circuitry where necessary. Communication interface 566 can provide for communications under various modes or protocols, including, e.g., GSM voice calls, SMS, EMS, or MMS messaging, CDMA, TDMA, PDC, WCDMA, CDMA2000, or GPRS, among others. Such communication can occur, for example, through radio-frequency transceiver 568. In addition, short-range communication can occur, including, e.g., using a Bluetooth®, WiFi, or other such transceiver (not shown). In addition, GPS (Global Positioning System) receiver module 570 can provide additional navigation- and location-related wireless data to device 550, which can be used as appropriate by applications running on device 550.

Device 550 also can communicate audibly using audio codec 560, which can receive spoken data from a user and convert it to usable digital data. Audio codec 560 can likewise generate audible sound for a user, including, e.g., through a speaker, e.g., in a handset of device 550. Such sound can include sound from voice telephone calls, can include recorded sound (e.g., voice messages, music files, and the like) and also can include sound generated by applications operating on device 550.

Computing device 550 can be implemented in a number of different forms, as shown in the figure. For example, it can be implemented as cellular telephone 580. It also can be implemented as part of smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

For situations in which the systems and techniques discussed herein collect personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (e.g., to a city, zip code, or state level), so that a particular location of the user cannot be determined.

In some implementations, the engines described herein can be separated, combined or incorporated into a single or combined engine. The engines depicted in the figures are not intended to limit the systems described here to the software architectures shown in the figures.

All processes described herein and variations thereof (referred to as “the processes”) contain functionality to ensure that party privacy is protected. To this end, the processes may be programmed to confirm that a user's membership in a social networking account is publicly known before divulging, to another party, that the user is a member. Likewise, the processes may be programmed to confirm that information about a party is publicly known before divulging that information to another party, or even before incorporating that information into a social graph.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A method performed by one or more processing devices, comprising:
obtaining one or more search terms;
generating, based on the one or more search terms, an interactive search query that is associated with at least one control for (i) annotating the interactive search query in a social network, or (ii) sharing the interactive search query in the social network;
receiving, through a visual representation of the interactive search query rendered on a computer display of a client device of a first user, data indicative of a selection of the at least one control that represents an annotation of or a sharing of the interactive search query;
in response to the selection, generating a data object for the one or more search terms of the interactive search query, with the data object comprising (i) the one or more search terms, and (ii) the annotation of the interactive search query or information indicative of the sharing of the interactive search query;
updating the data object with information specifying a number of actions that were performed with regard to the one or more search terms by users of the social network, with the users comprising (i) the first user, and (ii) other users who differ from each of the first user and users that share social connections with the first user in the social network;
identifying a second user of the social network that shares a social connection with the first user in the social network, with the social connection being established independent of interactions with the interactive search query by the first user and the second user; and
populating an activity stream in the social network of the second user with a visual representation of the data object for the interactive search query to enable the second user to view the visual representation, with the visual representation comprising (i) the annotation of the interactive search query or the information indicative of the sharing of the interactive search query, and (ii) the number of actions that were performed with regard to the one or more search terms by the users of the social network, along with the one or more search terms for the interactive search query.

2. The method of claim 1, further comprising:
generating data for a graphical user interface that depicts the activity stream; and
sending the graphical user interface to the client device.

3. The method of claim 1, wherein the number of actions that were performed with regard to the one or more search terms by the users of the social network comprises:
a number of annotations that pertain to the one or more search terms in the social network;
a number of views of the one or more search terms in the social network; or a number of times the one or more search terms are shared in the social network.

4. The method of claim 1, further comprising:
analyzing the data indicative of the selection of the at least one control.

5. The method of claim 1, further comprising:
analyzing one or more metrics for the one or more search terms;
wherein at least one of the one or more metrics comprises one or more of:
a measure of a number of users that has viewed the one or more search terms of the interactive search query; and
a measure of a number of users that has searched on the one or more search terms.

6. (canceled)

7. The method of claim 1, wherein the annotation comprises one or more of:
data indicative of a comment about the one or more search terms; and
data indicative of an endorsement of the one or more search terms.

8. One or more machine-readable hardware storage devices storing instructions that are executable by one or more processing devices to perform operations comprising:
obtaining one or more search terms;
generating, based on the one or more search terms, an interactive search query that is associated with at least one control for (i) annotating the interactive search query in a social network, or (ii) sharing the interactive search query in the social network;
receiving, through a visual representation of the interactive search query rendered on a computer display of a client device of a first user, data indicative of a selection of the at least one control that represents an annotation of or a sharing of the interactive search query;
in response to the selection, generating a data object for the one or more search terms of the interactive search query, with the data object comprising (i) the one or more search terms, and (ii) the annotation of the interactive search query or information indicative of the sharing of the interactive search query;
updating the data object with information specifying a number of actions that were performed with regard to the one or more search terms by users of the social network, with the users comprising (i) the first user, and (ii) other users who differ from each of the first user and users that share social connections with the first user in the social network;
identifying a second user of the social network that shares a social connection with the first user in the social network, with the social connection being established independent of interactions with the interactive search query by the first user and the second user; and
populating an activity stream in the social network of the second user with a visual representation of the data object for the interactive search query to enable the second user to view the visual representation, with the visual representation comprising (i) the annotation of the interactive search query or the information indicative of the sharing of the interactive search query, and (ii) the number of actions that were performed with regard to the one or more search terms by the users of the social network, along with the one or more search terms for the interactive search query.

9. The one or more machine-readable hardware storage devices of claim 8, wherein the operations further comprise:
generating data for a graphical user interface that depicts the activity stream; and
sending the graphical user interface to the client device.

10. The one or more machine-readable hardware storage devices of claim 8, wherein the number of actions that were performed with regard to the one or more search terms by the users of the social network comprises:
a number of annotations that pertain to the one or more search terms in the social network;
a number of views of the one or more search terms in the social network; or
a number of times the one or more search terms are shared in the social network.

11. The one or more machine-readable hardware storage devices of claim 8, wherein the operations further comprise:
analyzing the data indicative of the selection of the at least one control.

12. The one or more machine-readable hardware storage devices of claim 8, wherein the operations further comprise:
analyzing one or more metrics for the one or more search terms;
wherein at least one of the one or more metrics comprises one or more of:
a measure of a number of users that has viewed the one or more search terms of the interactive search query; and
a measure of a number of users that has searched on the one or more search terms.

13. (canceled)

14. The one or more machine-readable hardware storage devices of claim 8, wherein the annotation comprises one or more of:
data indicative of a comment about the one or more search terms; and
data indicative of an endorsement of the one or more search terms.

15. An electronic system comprising:
one or more processing devices; and
one or more machine-readable hardware storage devices storing instructions that are executable by the one or more processing devices to perform operations comprising:
obtaining one or more search terms;
generating, based on the one or more search terms, an interactive search query that is associated with at least one control for (i) annotating the interactive search query in a social network, or (ii) sharing the interactive search query in the social network;
receiving, through a visual representation of the interactive search query rendered on a computer display of a client device of a first user, data indicative of a selection of the at least one control that represents an annotation of or a sharing of the interactive search query;
in response to the selection, generating a data object for the one or more search terms of the interactive search query, with the data object comprising (i) the one or more search terms, and (ii) the annotation of the interactive search query or information indicative of the sharing of the interactive search query;
updating the data object to represent with information specifying a number of actions that were performed with regard to the one or more search terms by users of the social network, with the users comprising (i) the first user, and (ii) other users who differ from each of the first user and users that share social connections with the first user in the social network;
identifying a second user of the social network that shares a social connection with the first user in the social network, with the social connection being established independent of interactions with the interactive search query by the first user and the second user; and
populating an activity stream in the social network of the second user with a visual representation of the data object for the interactive search query to enable the second user to view the visual representation, with the visual representation comprising (i) the annotation of the interactive search query or the information indicative of the sharing of the interactive search query, and (ii) the number of actions that were performed with regard to the one or more search terms by the users of the social network, along with the one or more search terms for the interactive search query.

16. The electronic system of claim 15, wherein the operations further comprise:
generating data for a graphical user interface that depicts the activity stream; and
sending the graphical user interface to the client device.

17. The electronic system of claim 15, wherein the number of actions that were performed with regard to the one or more search terms by the users of the social network comprises:
a number of annotations that pertain to the one or more search terms in the social network;
a number of views of the one or more search terms in the social network; or
a number of times the one or more search terms are shared in the social network.

18. The electronic system of claim 15, wherein the operations further comprise:
analyzing the data indicative of the selection of the at least one control.

19. The electronic system of claim 15, wherein the operations further comprise:
analyzing one or more metrics for the one or more search terms;
wherein at least one of the one or more metrics comprises one or more of:
a measure of a number of users that has viewed the one or more search terms of the interactive search query; and
a measure of a number of users that has searched on the one or more search terms.

20. (canceled)

21. The electronic system of claim 15, wherein the annotation comprises one or more of:
data indicative of a comment about the one or more search terms; and
data indicative of an endorsement of the one or more search terms.
